(19) United States
(12) Patent Application Publication
(10) Pub. No.: US 2014/0370183 A1
(43) Pub. Date: Dec. 18, 2014

(54) Method Of Restoring A System Of Pipes

(71) Applicants: Roy A. Terry, Laguna Niguel, CA (US); Ryan A. Terry, Trabuco Canyon, CA (US); Michael T. Terry, Laguna Niguel, CA (US)

(72) Inventors: Roy A. Terry, Laguna Niguel, CA (US); Ryan A. Terry, Trabuco Canyon, CA (US); Michael T. Terry, Laguna Niguel, CA (US)

(21) Appl. No.: 14/287,788

(22) Filed: May 27, 2014

Related U.S. Application Data
(60) Provisional application No. 61/834,897, filed on Jun. 14, 2013.

(51) Int. Cl. B29C 73/02; B05D 1/00

(52) U.S. Cl. CPC B29C 73/02; B05D 1/00
USPC 427/8

(57) ABSTRACT

A method of restoring a system of pipes preferably includes the steps of preparation of the system; airflow mapping the system; drying and cleaning the system of pipes; injecting the interior coating material into each system inlet; monitoring and controlling airflow rates through the system of pipes to track the progression of the liquid coating; curing or drying the interior coating; and airflow mapping the pipe system upon completion. The system restoration method preferably uses a multiple line control box, a media injection system, an air compressor and a coating dispensing system at an inlet of the leaking pipe. The system restoration method preferably uses a coating overflow receiver, a muffler and a dust collector at an outlet of the system of pipes.

### CROSS-REFERENCES TO RELATED APPLICATIONS

This is a utility patent application taking priority from provisional application No. 61/834,897 filed on Jun. 14, 2013.

### BACKGROUND OF THE INVENTION

1. Field of the Invention

The present invention relates generally to pipes and more specifically to a method of restoring a system of pipes, which provides a cost effective alternative to replacing or making exterior repairs to the system of pipes.

2. Incorporation by Reference

Applicant hereby incorporates by reference U.S. patent application Ser. No. 13/710,539, filed on Dec. 11, 2012 in its entirety into this patent application.

### DISCUSSION OF THE PRIOR ART

It is well known that installed systems of small diameter pipes will fail over time, due to internal wear from the passing of fluid through the piping system or internal corrosion of the piping system. The system of pipes are varied and may include installed potable water distribution and fire suppression systems within buildings; natural gas distribution systems both within buildings and under installed site work outside buildings; as well as other varied systems for distributing and collecting both gas and liquid materials. The piping may be fabricated from steel, lead, cast iron, copper, plastics and other materials as commonly utilized in construction and industry.

The state of the art method of internally cleaning and coating a system of aged piping for restoration, or proactively protecting newer systems of piping to prevent wear and corrosion includes blowing out, cleaning and epoxy coating the interior of the pipes, utilizing compressed air as the delivery vehicle for the cleaning and coating process. The above process is well known and in use worldwide.

The Toyo Lining Co., LLC of Japan pioneered the air driven method for restoration of systems of installed drinking water lines and obtained a government approval for the process known as the “AS Method” in 1981. U.S. Pat. No. 5,013,725 (1991) to Werner Naf added the additional step of sealing leaks by the introduction of sealants carried by water into the system of pipes to be restored, before blowing out and lining the internal perimeter of the pipes. Patent no. CA 1,311,912 (1992) to Werner Naf also taught the use of a vacuum applied to the system outlet combined with compressed air. U.S. Pat. No. 7,858,149 to Gillanders added measured fiber and fillers to the coating material to be introduced into the system of pipes for sealing of larger leaks.

The state of the art has remained virtually unchanged in the application and control methods employed since the documentation of the AS Method in 1981 and the drawbacks of the process are well known. The drawbacks include the inability to identify restricted or damaged sections of piping, restricted flow through the system due to un-effaced coatings, coating that has blocked or restricted tees at pipe intersections and the inability to gauge the progression of the coating through the system of pipes being treated during the application of the process. It has also proved difficult to map systems of installed piping to determine pipe sizes in order to design coating loads to be introduced into each inlet to be coated.

Timing to complete a larger system of pipes is also an issue as the current art only teaches the introduction of coating into one inlet of the system to be restored at a time. Within the state of the art, the only process measurement employed to determine the progress of the internal liquid coating has been the pressure recorded at each inlet to the system of piping to be treated. The observation of pressure variations between treated inlets is used to determine coating progression and effacement during the lining step of the process. An improved method for process application and quality control is clearly needed in the art.

Accordingly, there is a clearly felt need in the art for a method of restoring a system of pipes, which includes internal cleaning and restoring installed systems of small diameter pipes by cleaning the interior walls of the pipe system and applying an internal liquid protective coating; and cleaning and coating the system by the introduction of a measured stream of compressed air at a temperature, pressure and a controlled air flow rate into each inlet of a system to be repaired and coated.

### SUMMARY OF THE INVENTION

The present invention provides a method of restoring a system of pipes, which provides a cost effective alternative to replacing or making exterior repairs to the system of pipes. The system of pipes includes a plurality of inlets and an outlet. The method of restoring a system of pipes (system of pipes restoration method) preferably includes preparation of the system; airflow mapping the system; drying and cleaning the system; injecting the interior coating material into each system inlet; monitoring airflow rates through the system to track the progression of the liquid coating; curing or drying the interior coating; and airflow mapping the pipe system upon completion.

The system of pipes restoration method preferably uses an air compressor, an air dryer, a multiple line control box, a media injection system and a coating injection system at the plurality of inlets of the system of pipes. The multiple line control box may be replaced with a plurality of single line control boxes depending upon the number of inlets to be treated. The system of pipes restoration method preferably uses a coating receiver, dust collector and muffler at the outlet of the system of pipes. The multiple line control box preferably includes a plurality of control valves, a plurality of pressure gages, a plurality of flow meters, and a plurality of air outlets. The media injection system includes an air inlet, a media reservoir inlet, a media valve, a media reservoir, a media outlet and a flow tube. The air inlet is connected to the plurality of outlets of the multiple line control box. The air compressor and the coating injection system may both be purchased from any number of manufacturers.

The air compressor is preferably connected to the air inlet of the air dryer; an outlet of the air dryer is connected to the inlet of the multiple line control box; and the outlet of the multiple line control box is connected to air inlets of a plurality of clear inlet tubes. The plurality of clear inlet tubes are preferably inserted into a plurality of inlet pipes in the system of pipes. The media injection system and coating injection system are preferably installed between the outlet of the multiple line control box and the plurality of clear inlet tubes.

The process starts by preparation of the system of pipes by surveying the system layout for pipe sizes and lengths; and removing fixtures, devices, valves or equipment from the points to become the inlets and outlets of the system of pipes. Airflow mapping of the system is implemented by measuring airflow rates through each system inlet at a given pressure. The interior surface of the system of pipes is dried by flowing compressed air therethrough from the multiple line control box. The interior surface of the system of pipes is cleaned by flowing sand blast media therethrough, which is dispensed by the media injection system. The drying and cleaning is also done by the specified type of system of pipes to be restored. The system of pipes is dried and cleaned by the method and material specified for the type of system to be restored. The interior of each system of pipes is injected with an interior coating material, utilizing compressed air, at a specified temperature and pressure and metered to specific air flow rates. The air flow rates are monitored through each inlet to track the progression of the liquid coating in the system. The interior coating is cured or dried by metering heated airflow through each inlet for the required time. Airflow mapping is done on the system upon completion of lining process to confirm system performance. Finally, the system is returned to its intended purpose by reconnecting the system fixtures, valves or other components to the inlets from which they were removed.

Accordingly, it is an object of the present invention to provide a system of pipes restoration method, which includes application of internal coatings controlled by air flow measurement at each inlet to the system to be treated.

It is another object of the present invention to provide a system of pipes restoration method, which includes detection of damaged or restricted sections of piping by measuring airflow through each inlet of the system to be restored.

It is a further object of the present invention to provide a system of pipes restoration method, which includes an estimation of pipe sizes by combining air flow rates measured through each inlet of the system to be restored.

It is yet a further object of the present invention to provide a system of pipes restoration method, which accelerates the internal coating process by allowing for liquid coating to be introduced into multiple inlets simultaneously as increased airflow measurements allow.

It is yet a further object of the present invention to provide a system of pipes restoration method, which includes tracking and controlling effacement of the coating within the system of pipes to be treated by controlling airflow volumes, not just measuring airflow through each inlet of the system.

It is yet a further object of the present invention to provide a system of pipes restoration method, which insures that all pipe intersections are kept clear during the coating application by measuring and controlling airflow rates through each inlet of the system to be restored.

It is yet a further object of the present invention to provide a system of pipes restoration method, which prevents blockages by metering and measuring airflow into already lined inlets at specific rates.

Finally, it is another object of the present invention to provide a system of pipes restoration method, which logs the performance of the restored system by measuring the airflow through each inlet of the system.

These and additional objects, advantages, features and benefits of the present invention will become apparent from the following specification.

### BRIEF DESCRIPTION OF THE DRAWINGS

FIG. 1 is a flow chart of a system of pipes restoration method in accordance with the present invention.

FIG. 2 is a schematic diagram of a system of pipes restoration method in accordance with the present invention.

FIG. 3 is a schematic diagram of a multiple line control box of a pipe restoration method in accordance with the present invention.

FIG. 4 is a schematic diagram of an injection system of a system of pipes restoration method in accordance with the present invention.

FIG. 5 is a schematic diagram of an air dryer of a system of pipes restoration method in accordance with the present invention.

### DETAILED DESCRIPTION OF THE PREFERRED EMBODIMENTS

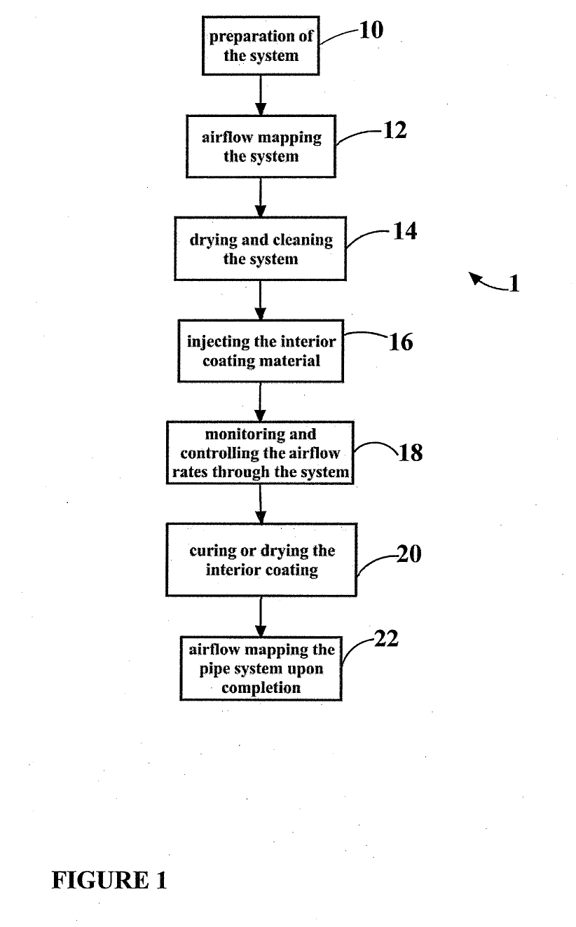

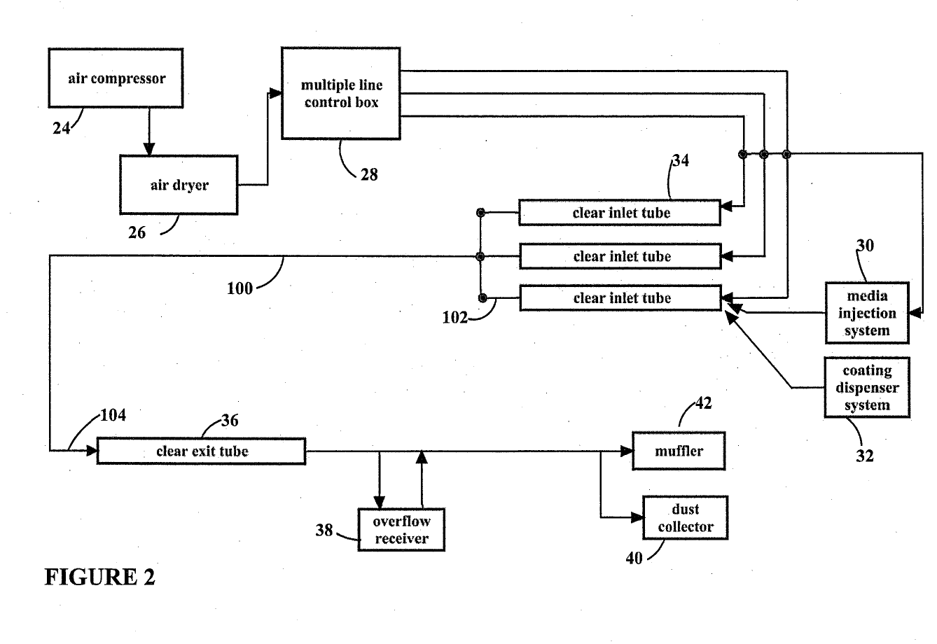

With reference now to the drawings, and particularly to FIG. 1, there is shown a flow chart of a system of pipes restoration method 1. With reference to FIG. 2, the system of pipes restoration system 1 has been found to be satisfactory in coating a system of pipes 100 in dry fire suppression systems, gas pipe systems, water systems and compressed air systems. Dry fire suppression systems are normally charged with compressed air. These systems of small diameter pipes are known to develop internal pinhole leaks due to corrosion and can benefit from the application of an internal coating for repair and protection.

Gas pipe systems for residential and commercial buildings, and gas systems serving site improvements such as pools, spas barbecues and the like, both above and below grade are known to develop leaks, which may be repaired and protected by an internal coating. Water systems within buildings consisting of copper, steel, lead, brass and other metals are known to fail due to internal corrosion as well as leach heavy metals and other impurities into the drinking water. These systems can benefit from the application of an internal coating to repair and protect the piping. Compressed air systems servicing factories and industry, steel piping in these systems is known to fail due to internal corrosion from water carried in the air stream.

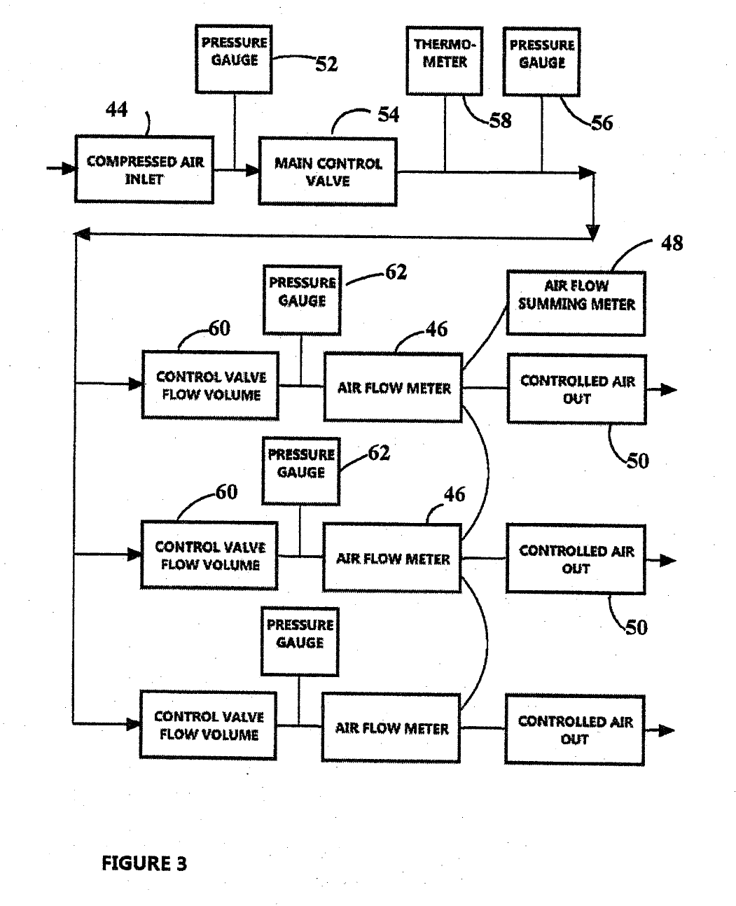

The system of pipes 100 includes a plurality of inlets 102 and an outlet 104. With reference to FIG. 3, the system of pipes restoration method 1 preferably includes the steps of preparation of the system in process block 10; airflow mapping the system in process block 12; drying and cleaning the system in process block 14; injecting the interior coating material into each system inlet in process block 16; monitoring and controlling airflow rates through the system to track the progression of the liquid coating in process block 18; curing or drying the interior coating in process block 20; and airflow mapping the pipe system upon completion in process block 22.

The system of pipes restoration method 1 preferably uses an air compressor 24, an air dryer 26, a multiple line control box 28, a media injection system 30, a coating injection system 32 and a plurality of clear injection tubes 34 at the plurality of inlets 102 of the system of pipes 100. The multiple line control box 28 may be replaced with a plurality of single line control boxes depending upon the number of inlets to be treated. A single line control box 24 is disclosed in patent application Ser. No. 13/710,539. The air compressor 24 preferably generates airflow with a pressure up to 175 psi at a flow rate of 375 cfm. The system of pipes restoration method 1 preferably uses a plurality of clear outlet tubes 36, a coating receiver 38, a dust collector 40 and a muffler 42 at the outlet 104 of the system of pipes 100. The media injection system 30 and the coating dispensing system 32 are applied to at least one inlet 102 at a time.

The multiple line control box 28 preferably includes an air inlet 44, a plurality of control valves, a plurality of pressure gages, a plurality of air flow meters 46, an air summing meter 48 and a plurality of air outlets 50. An output of the air compressor 24 is preferably coupled to the compressed air inlet 44 through an air dryer 26. A first pressure gage 52 measures the pressure of the air from the air compressor 24. A control valve 54 may be used to shut-off airflow through the multiple line control box 28. A second pressure gage 56 measures the pressure at an output of the main control valve 54 and a thermometer 58 measures the temperature at the output of the main control valve 54. Each air flow control valve 60 is used to control the volume of air traveling into one of the inlets 102. A third pressure gage 62 is used to measure the pressure of the air flow into one of the inlets 102. Each air flow meter 46 provides a reading of the volume of airflow (preferably measured in cubic feet per minute (cfm)) flowing from the air flow control valve 60 into one of the inlets 102. The air flow summing meter 48 sums the air flow through the plurality of air flow meters 46.

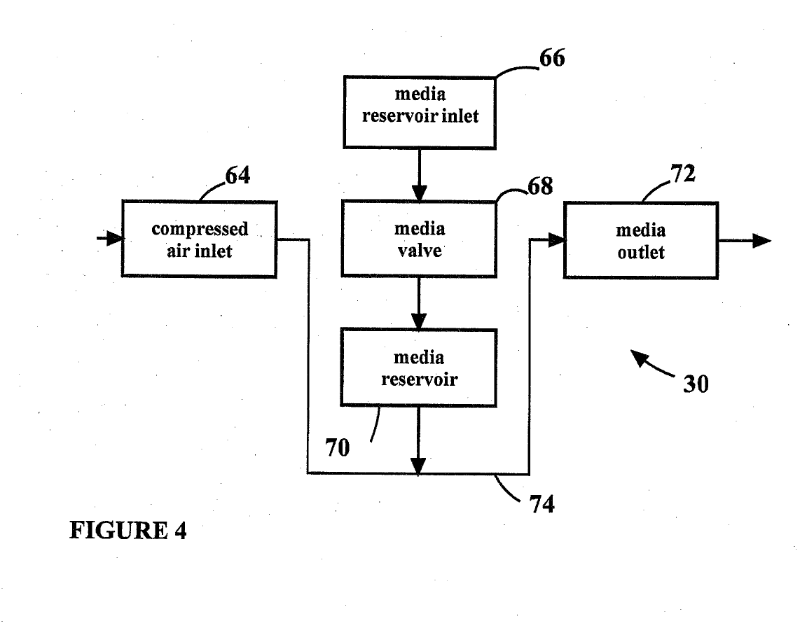

With reference to FIG. 4, the media injection system 30 includes an air inlet 64, a media reservoir inlet 66, a media valve 68, a media reservoir 70, a media outlet 72 and a flow tube 74. The air inlet 64 is connected to the plurality of outlets 50 of the multiple line control box 28. The air compressor 24 and the coating injection system 32 both can be purchased from any number of manufacturers. Sand blast media is poured into the media reservoir inlet 66. The sand blast media flows into the media reservoir 70, when the media valve 68 is opened. The sand blast media flows into the flow tube 74 and is transported through the media injection system 30 by airflow from the multiple line control box 24. The sand blast media is preferably 23-30 garnet for copper water lines. The media reservoir 70 is filled with media for cleaning and pre-sealing an inside of the leaking pipe 100. The media outlet 72 is coupled to at least one of the clear inlet tubes 34. The coating dispensing system 30 can be purchased from any number of manufacturers.

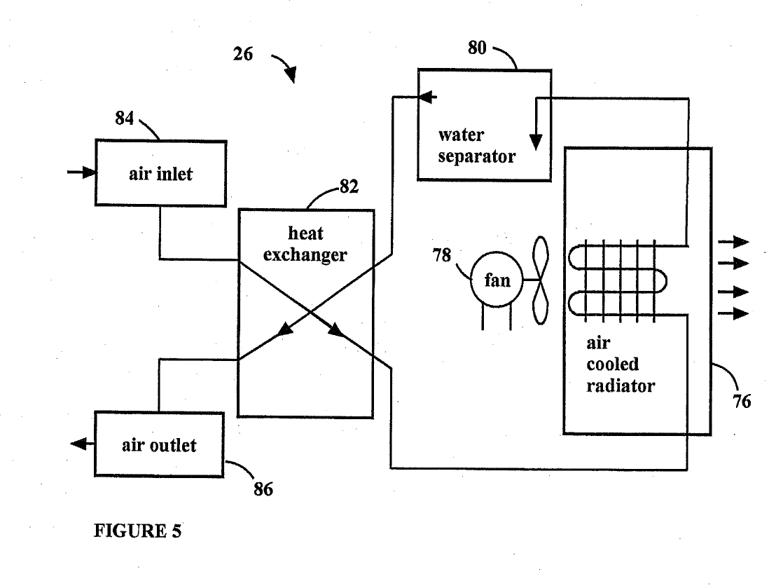

With reference to FIG. 5, the air dryer 26 preferably includes a radiator 76, a fan 78, a water separator 80 and a heat exchanger 82. The air compressor 24 is connected to an air inlet 84 of the air dryer 26; an outlet 86 of the air dryer 26 is connected to the inlet 44 of the multiple line control box 28; and the plurality of outlets 50 of the control box 28 are connected to plurality of clear inlet tubes 34. The media outlet 72 of the media injection system 30 is connected to at least one of the plurality of clear inlet tubes 34. The other end of the plurality of clear inlet tubes 34 are preferably inserted into the plurality of inlet pipes 102 in the system of pipes 100.

One end of the clear outlet tube 36 is connected to the outlet 104 of the system of pipes 100. The other end of the clear outlet tube 36 is coupled to the coating overflow receiver 38, the dust collector 40 and the muffler 42. Excess liquid coating material and leak sealing media is caught in the coating overflow receiver 38. The air exiting the system of pipes 100 is filtered with the dust collector 40 and the sound of the air exiting the system of pipes is muffled with the muffler 42.

The system of pipes restoration method 1 is started in process block 10 by surveying the system layout for pipe sizes and lengths; and removing fixtures, devices, valves or equipment from the points to become the inlets and outlets of the system of pipes 100. Airflow mapping of the system of pipes 100 is implemented by measuring airflow rates through each system inlet 102 at a given pressure with the plurality of air flow meters 46 in process block 12. In process block 14, the interior surface of the system of pipes 100 is dried by flowing compressed air therethrough from the multiple line control box 28. The interior surface of the system of pipes 100 is cleaned by flowing sand blast media therethrough, which is dispensed by the media injection system 30. The drying and cleaning is also done by the specified type of system of pipes 100 to be restored. In process block 16, the interior of each system of pipes 100 is injected with an interior coating material from the coating dispenser system 32, utilizing compressed air, at a specified temperature and pressure and metered to specific airflow rates.

In process block 18, the airflow rates are monitored and controlled through each inlet 102 to track the progression of the liquid coating in the system with the plurality of air flow meters 46. In process block 20, the interior coating is cured or dried by metering heated airflow through each inlet 102 for the required time. In process block 22, airflow mapping is done on the system upon completion of lining process to confirm system performance. Finally, the system is returned to its intended purpose by reconnecting the system fixtures, valves or other components to the inlets from which they were removed.

While particular embodiments of the invention have been shown and described, it will be obvious to those skilled in the art that changes and modifications may be made without departing from the invention in its broader aspects, and therefore, the aim in the appended claims is to over all such changes and modifications as fall within the true spirit and scope of the invention.

I claim:

1. A method of restoring a system of pipes, comprising the steps of:
measuring air flow volume through the system of pipes;
drying and cleaning an interior surface of the system of pipes;
injecting coating material into each inlet of the system of pipes;
monitoring air flow volume through the system of pipes to track the progression of the liquid coating; and
curing and drying the coating material.

2. The method of restoring a system of pipes of claim 1, further comprising the step of:
connecting a clear tube to at least one inlet of the leaking pipe.

3. The method of restoring a system of pipes of claim 1, further comprising the step of:
using a sand blasting media to clean the interior surface of the system of pipes.

4. The method of restoring a system of pipes of claim 1, further comprising the step of:
providing an air flow control valve for controlling the volume of air traveling into at least one of a plurality of inlets of the system of pipes.

5. The method of restoring a system of pipes of claim 4, further comprising the step of:
providing an air flow meter for measuring the air flow volume of at least one of the plurality of inlets.

6. The method of restoring a system of pipes of claim 5, further comprising the step of:
providing a summing air flow meter for adding the measure of air flow volume through each air flow meter.

7. The method of restoring a system of pipes of claim 1, further comprising the step of:
connecting a clear tube to an outlet of the system of pipes.

8. A method of restoring a system of pipes, comprising the steps of:
measuring air flow volume through the system of pipes;
drying and cleaning an interior surface of the system of pipes;
injecting coating material into each inlet of the system of pipes;
monitoring air flow volume through the system of pipes to track the progression of the liquid coating;
curing and drying the coating material; and
measuring air flow volume through the system of pipes upon completion of the restoration.

9. The method of restoring a system of pipes of claim 8, further comprising the step of:
connecting a clear tube to at least one inlet of the leaking pipe.

10. The method of restoring a system of pipes of claim 8, further comprising the step of:
using a sand blasting media to clean the interior surface of the system of pipes.

11. The method of restoring a system of pipes of claim 8, further comprising the step of:
providing an air flow control valve for controlling the volume of air traveling into at least one of a plurality of inlets of the system of pipes.

12. The method of restoring a system of pipes of claim 11, further comprising the step of:
providing an air flow meter for measuring the air flow volume of at least one of the plurality of inlets.

13. The method of restoring a system of pipes of claim 12, further comprising the step of:
providing a summing air flow meter for adding the measure of air flow volume through each air flow meter.

14. The method of restoring a system of pipes of claim 8, further comprising the step of:
connecting a clear tube to an outlet of the system of pipes.
